(19) United States
(12) Patent Application Publication
(10) Pub. No.: US 2006/0024593 A1
(43) Pub. Date: Feb. 2, 2006

(54) Optical device and manufacturing method thereof

(75) Inventors: Shinji Maruyama, Kawasaki (JP); Seiichi Ikeda, Kawasaki (JP); Koji Terada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED

(21) Appl. No.: 11/023,475

(22) Filed: Dec. 29, 2004

Related U.S. Application Data
(63) Continuation of application No. PCT/JP02/09295, filed on Sep. 11, 2002.

(51) Int. Cl. G03C 5/00

(52) U.S. Cl. 430/25

(57) ABSTRACT

An optical device for receiving a light and changing a transmission direction of the received light is disclosed. The optical device includes a substrate having a surface with which the received light is transmitted in parallel; a layer formed on the surface of the substrate; and a reflecting face formed in the layer, the reflecting face being inclined and reflecting the received light to change the transmission direction of the received light.

### CROSS-REFERENCE TO RELATED APPLICATION

This application is a U.S. continuation application filed under 35 USC 111(a) claiming benefit under 35 USC 120 and 365(c) of PCT International Application No. PCT/JP02/09295 filed on Sep. 11, 2002, which is hereby incorporated herein by reference.

### BACKGROUND OF THE INVENTION

The present invention generally relates to optical devices and methods of manufacturing the optical devices, and more particularly, to an optical device used for optical communication or optical pickup, and a manufacturing method thereof.

Conventionally, optical devices employing a light waveguide path have been utilized for optical switches. For example, as described in an article, A. Himeno et. al., “Silica-Based Planar Lightwave circuits”, IEEE. J. Selected Topics Quantum Electronics, vol. 4, no. 6, pp. 913, 1998, an optical device using a Mach Zender interferometer circuit to switch light path is known.

In such an optical device, a part of a signal light is taken out to an upper direction and received by a photodiode (PD), for measuring the amount of light. In order to take out the signal light, the optical device has a recess on a substrate, and the recess has at least one inclination face for reflecting the received signal light.

In order to form a recess in a layer, dry etching processes such as a reactive ion etching process are normally used. When such a recess with a substantially vertical wall (vertical face) and an inclined wall (inclined face) is formed on the substrate, a mask for etching the inclined portion is required to be inclined also.

For example, if an etching selective ratio between mask material and etched material is assumed to be 1, the mask generally should have an inclined portion whose angle is the same as that of the material to be etched, as shown in FIG. 1.

In FIG. 1, on a substrate 10, a layer 12 to be etched is formed. On the layer 12, a mask 14 and a mask 15 are formed. The mask 14 has a vertical face 14a, and the mask 15 has an inclined face 15a.

Instead of inclining the face 15a of the mask 15, a mask 16 may have a step-like face 16a by overlaying plural layers with shifting one by one, as shown in FIG. 2. The mask 16 having the step-like face 16a can be used for etching an inclined face in the layer 12. However, in order to smooth the step-like face 16a, the number of steps should be increased, requiring many processes such as multiple times of applying resists, exposing and developing.

The incrementing of the number of processes worsens mask accuracy, makes inclined faces uneven, and increases manufacturing costs.

### SUMMARY OF THE INVENTION

A general object of the present invention is to provide optical devices and methods for manufacturing thereof, which avoid incrementing the number of processes, provide accurate masks, reduce unevenness of inclination faces, and reduce manufacturing costs.

The above object of the present invention is achieved by an optical device for receiving a light and changing a transmission direction of the received light, comprising: a substrate having a surface with which the received light is transmitted in parallel; a layer formed on the surface of the substrate; and a reflecting face formed in the layer, the reflecting face being inclined and reflecting the received light to change the transmission direction of the received light.

### BRIEF DESCRIPTION OF THE DRAWINGS

FIG. 1 illustrates a prior art method for forming an inclined face;

FIG. 2 illustrates another prior art method for forming an inclined face;

FIG. 3 is a plan view of a mask according to an embodiment of the present invention;

FIG. 4 is a cross-sectional view of an optical device according to the embodiment of the present invention;

FIG. 5 is a plan view of a mask according to another embodiment of the present invention;

FIG. 6 is a cross-sectional view of an optical device according to another embodiment of the present invention;

FIGS. 7A through 7D illustrate manufacturing process steps according to the embodiment of the present invention;

FIGS. 8A and 8B are a plan view of a mask and a cross-sectional view of an optical device, respectively, according to a further embodiment of the present invention; and

FIG. 9 is a perspective view of a communication device to which the present invention is applicable.

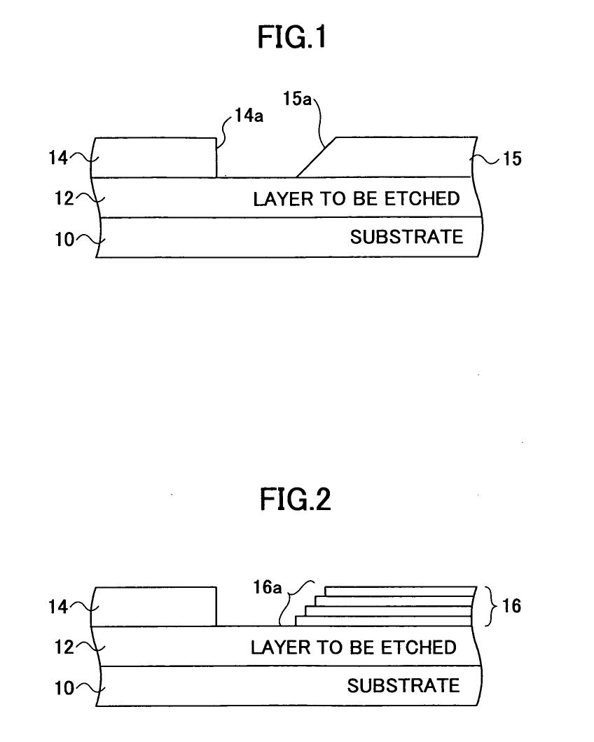

### DESCRIPTION OF THE PREFERRED EMBODIMENTS

The following is a description of embodiments of the present invention, with reference to the accompanying drawings.

In the embodiments of the present invention, one process of dry etching utilizing the micro loading effect can form a recess with a vertical side wall (vertical face) and an inclined side wall (inclined face). The micro loading effect is an effect that etching rates differ depending on area sizes of regions to be etched in an etching process, that is, the smaller the area size is, the lower the etching rate is. The present inventors found that it is possible to control the micro loading effect by adequately selecting mask shape and thereby obtain an etched inclined face with a desired inclination.

In order to form such a recess with a vertical face and an inclined face in one process, an opening of a mask is narrowed over an upper portion of the inclined face and widened over a lower portion of the inclined face. In this manner, the difference in the width of the mask opening gives different etching rates of the inclined face. That is, the etching rate becomes higher under the widened opening of the mask, and becomes lower under the narrowed opening of the mask due to the micro loading effect, resulting in an inclined face. This method can drastically reduce process steps required for forming an inclined face, compared with step-like masks.

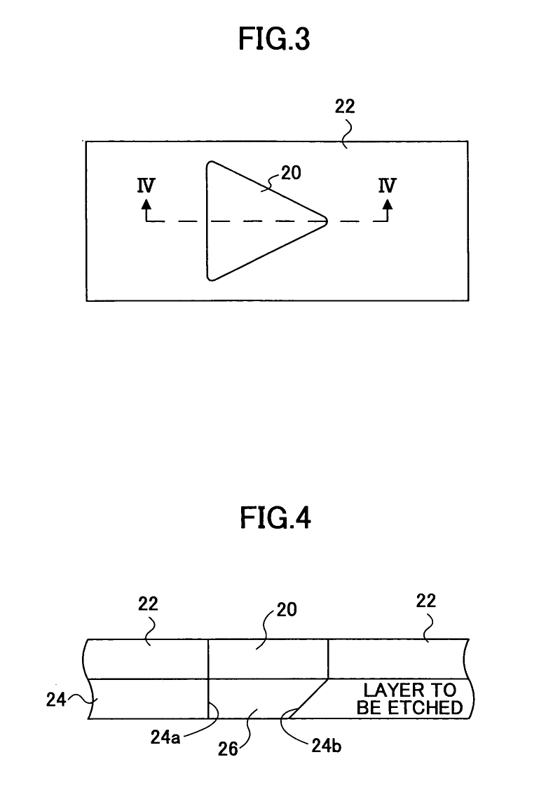

In an embodiment shown in FIG. 3, a mask 22 is formed, which has a mask opening 20 having a substantially triangle shape. By performing a reactive ion etching (RIE) process on a layer 24 using this mask 22, a recess 26 with a vertical face 24a and an inclined face 24b can be formed in the etched layer 24, as shown in FIG. 4. Needless to say, the mask 22 itself does not have to have an inclined portion.

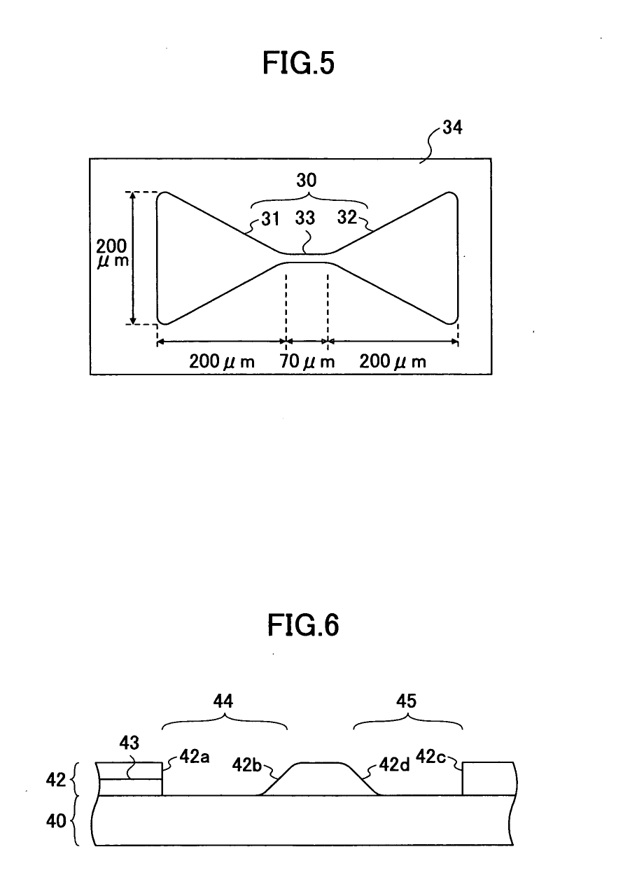

FIG. 5 is a plan view of a mask according to another embodiment of the present invention. A mask 34 is formed, which has a mask opening 30, as shown in FIG. 5. The mask opening 30 comprises a substantially triangle-shaped main opening 31, a substantially triangle-shaped dummy opening 32 and a connection opening 33 for connecting the tops of the two triangles 31 and 32.

The main opening 31 and the dummy opening 32 have 200 μm long base sides, which are orthogonal to the longitudinal axis of the connection opening 33. Both ends of the base sides are shaped as circular arcs having a curvature radius of 30 μm, in order to prevent from cracking from these ends when patterning the mask 34.

If all the three tops of the main opening 31 are shaped as circular arcs having a curvature radius of 30 μm, it becomes difficult to form by the micro loading effect an inclined face having enough inclination for reflecting. Accordingly, the facing tops of the main opening 31 and the dummy opening 32 are narrowed to 2 μm width and connected by the connection opening 33.

In this manner, the width at the top of the main opening 31 can be 2 μm, and it is possible to form by the micro loading effect an inclined face having enough inclination for reflecting, and to prevent cracking. The dummy opening 32 is formed in order to treat the end portion of the connection opening 33, and therefore it does not have to be a mirror image of the main opening 31.

FIG. 6 shows a cross section of the etched layer having a recess with a vertical face and an inclined face formed in accordance with the embodiment of the present invention. On a silicon substrate 40, a layer 42 to be etched is formed by the CVD method. The layer 42 has a thickness of about 50 μm and is made of mainly SiO₂. The layer 42 to be etched is provided a light waveguide path 43 therein.

The mask shown in FIG. 5 is overlaid on the layer 42 to be etched, and the RIE etching is performed so as to form a recess 44 with a vertical face 42a and an inclined face 42b in the layer 42 to be etched. The inclination angle of the inclined face 42b is 49.8°. The recess 44 is formed by the main opening 31 of the mask 34. Similarly, the recess 45 having a vertical face 42c and an inclined face 42d is formed by a dummy opening 32. The plan view shapes of the recesses 44 and 45 are the same as the shapes of the main opening 31 and the dummy opening 32 of the mask shown in FIG. 5.

A light passing through the light waveguide path 43 is emitted at the vertical face 42a into the recess 44 and reflected by the inclined face 42b to an upper direction in FIG. 6. Applying metal such as Au or Al by vapor deposition onto the inclination face 42b improves light reflectivity. After Au is vapor deposited onto the inclined face 42b, the recess 44 is filled with matching material and a photo diode is mounted along the light axis of the reflected light, then a monitor function is realized for monitoring the light passing through the light waveguide path 43.

Next, a manufacturing process in accordance with embodiments of the present invention is explained below.

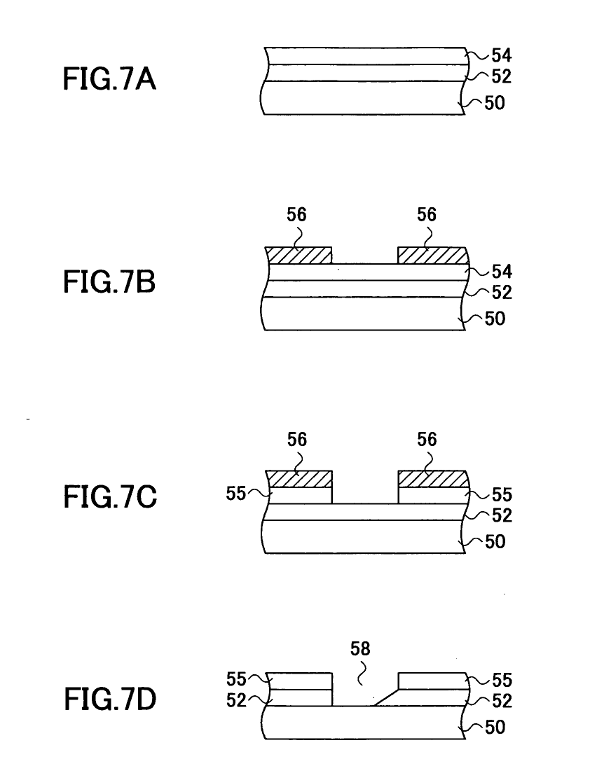

First, as shown in FIG. 7A, on a silicon substrate 50, a layer 52 to be etched is formed. The layer 52 is made of mainly SiO₂. The layer 52 to be etched is provided a light waveguide path therein. Further, on the whole top surface of layer 52, a chromic (Cr) layer 54 is formed as a mask.

Next, as shown in FIG. 7B, a resist 56 is formed, and then the resist 56 is partially removed at a mask position. Thereafter, the chromic layer 54 is etched using the resist 56, to obtain a chromic mask 55 as shown in FIG. 7C. The mask 55 has, for example, the shape as shown in FIG. 5.

Further, using the mask 55, the RIE is performed to form a recess 58 having a vertical face and an inclined face as shown in FIG. 7D.

In this manner, since the mask can be manufactured by only one process, it becomes possible to avoid increasing process steps, to give accurate masks, to reduce variation in inclination, and to reduce manufacturing cost.

The above embodiment is explained with respect to refection of the light emitted from the light waveguide path, but the present invention can also be applied to reflection of a light emitted from an optical fiber. It is possible to insert a light source such as a semiconductor laser or an optical diode within the recess, and reflect the light emitted from the light source. This structure can be utilized in a pick up device in CD or DVD players.

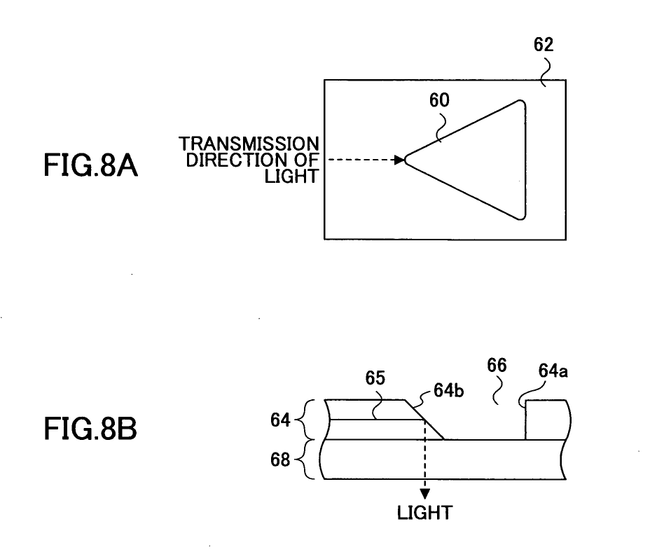

As shown in FIG. 8A, a mask 62 having a triangle opening 60 whose top is directed to an incident light can also be used for an RIE process. In this case, as shown in FIG. 8B, a recess 66 with an inclination face 64b and a vertical face 64a can be formed. Light passing through a light waveguide path 65 can be easily reflected to substrate 68 (lower direction in FIG. 8B.)

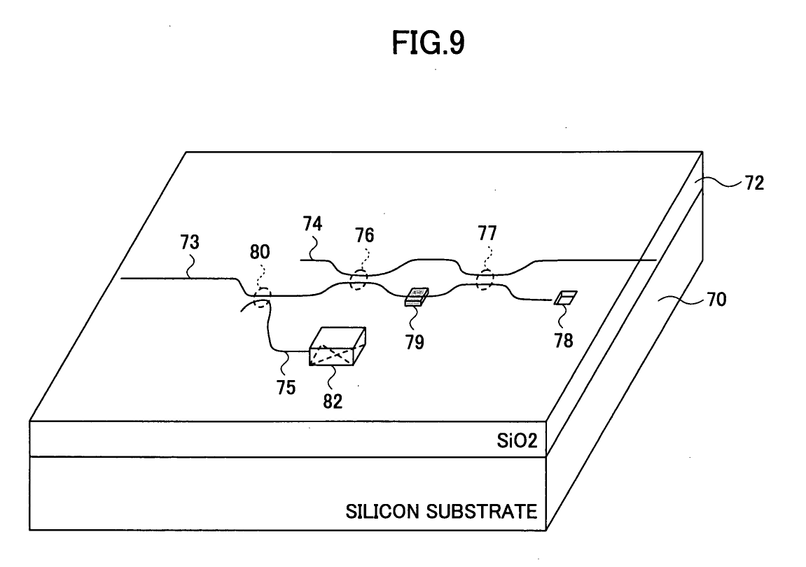

FIG. 9 is a perspective view of a communication device according to another embodiment of the present invention. On a silicon substrate 70, a light waveguide path forming layer 72 made of SiO₂ is formed. In the layer 72, light waveguide paths 73, 74 and 75 are formed. Light is input from the outside to one end of the light waveguide path 73. The other end of the light waveguide path 73 is terminated with a light shielding recess 78. The light waveguide path 74 emits light to the outside. The light waveguide paths 73 and 74 are arranged close to each other at two locations, where 3 dB couplers 76, 77 are formed. Between the 3 dB couplers 76 and 77, a heating element 79 is provided on the light waveguide path 73. Whether to drive the heating element 79 as a light switch determines whether to output the light signal from the light waveguide path 74.

The light waveguide paths 73 and 75 are placed close to each other at one location and constitute a light coupler 80 there. The coupler 80 divides 1/20 of the light passing through the light waveguide path 73 out to the light waveguide path 75. One end of the light waveguide path 75 is terminated with a recess 82 as shown in FIG. 6. A photo diode (not shown) is mounted over an inclined face of the recess 82, with a light receiving face of the diode being coaxial to a light reflected by the inclined face. The photodiode 84 can monitor the light transmitting through the light waveguide path 75.

It should be noted that the present invention is not limited to the embodiments specifically disclosed above, but other variations and modifications may be made without departing from the scope of the present invention.

What is claimed is:

1. An optical device for receiving a light and changing a transmission direction of the received light, comprising:
a substrate having a surface with which the received light is transmitted in parallel;
a layer formed on the surface of the substrate; and
a reflecting face formed in the layer, the reflecting face being inclined and reflecting the received light to change the transmission direction of the received light.

2. The optical device as claimed in claim 1, wherein
the reflecting face is an inclined face of a recess formed in the layer.

3. The optical device as claimed in claim 2, wherein
the inclined face is covered with a reflecting film.

4. The optical device as claimed in claim 3, wherein
the reflecting film is a metal film.

5. The optical device as claimed in claim 1, wherein
the light to be reflected by the reflecting face is emitted from a light waveguide path formed in the layer.

6. The optical device as claimed in claim 1, wherein
the light to be reflected by the reflecting face is emitted from a light emitting element.

7. A method for manufacturing the optical device as claimed in claim 2, comprising the step of:
forming the reflecting face by a process utilizing micro loading effect.

8. The method as claimed in claim 7, wherein,
the process is a reactive ion etching process.

9. The method as claimed in claim 8, wherein the process comprises the step of:
forming the recess using a mask that can form the inclined face and a vertical face of the recess simultaneously.

10. The method as claimed in claim 9, wherein
the mask has an opening whose width is increasing or decreasing in the transmission direction of the received light.

11. The method as claimed in claim 9, wherein
the mask has an opening whose width is decreasing and then increasing in the transmission direction of the received light.
